(19) United States
(12) Patent Application Publication
(10) Pub. No.: US 2014/0247593 A1
(43) Pub. Date: Sep. 4, 2014

(54) Connector And Led Light Bar

(71) Applicant: Shenzhen China Star Optoelectronics Technology Co. Ltd., Shenzhen, Guangdong (CN)

(72) Inventors: Gang Yu, Shenzhen City (CN); Jiaqiang Wang, Shenzhen City (CN)

(73) Assignee: Shenzhen China Star Optoelectronics Technology Co., Ltd., Shenzhen, Guangdong (CN)

(21) Appl. No.: 13/701,081

(22) PCT Filed: Nov. 26, 2012
(86) PCT No.: PCT/CN2012/085246

§ 371 Date: Nov. 30, 2012

(30) Foreign Application Priority Data
Nov. 16, 2012 (CN) 201210464991.X

(51) Int. Cl. F21S 4/00; H01R 13/00

(52) U.S. Cl. CPC F21S 4/008; H01R 13/00
USPC 362/249.02; 439/660

(57) ABSTRACT

The present invention discloses a connector and an LED light bar. The connector includes an input module and an output module, wherein the input module and the output module being electrically connected; the input module comprising at least two input interfaces, the input interface being for connecting to an external power supply, the output module being for electrical connection to all LEDs in at least two external areas. As such, the present invention realizes the use of a connector to control LEDs in a plurality of areas to increase the utilization of the connector and simplify the LED light bar structure. In the mean time, the improvement of the connector utilization results in the reduction in the number of connectors used so as to reduce the cost of LED light bar.

### BACKGROUND OF THE INVENTION

1. Field of the Invention

The present invention relates to the field of light-emitting diode (LED) light source techniques, and in particular to a connector and LED light bar.

2. The Related Arts

Due to the advantages of low power consumption, high luminance and long life span, LED light bar is widely applied to many fields, such as, furniture, car, advertisement, lighting, boats and home decoration. As LED technique develops and the demands on LED increase, LED light bar also becomes more complex.

In known technique, LED light bar usually comprises LED, single-jack connector and circuit board. The LED and the single-jack connector are disposed on the circuit board. LED is connected through the single-jack connector to the external power supply to obtain electricity for lighting. However, because of the limitation of the single-jack connector, a connector can only provide limited number of LED for connecting to external power supply. In a more complex LED light bar, more connectors will be required to supply the power, resulting in higher cost of light bar as well as inconvenience of LED light bar control.

### SUMMARY OF THE INVENTION

The technical sue to be addressed by the present invention is to provide an LED light bar, for improving the utilization of the connector and simplifying design structure.

The present invention provides a connector, which comprises: an input module and an output module, wherein the input module and the output module being electrically connected: the input module comprising at least two input interfaces, the input interface being a jack-type interface, the jack-type interface being for plugging in one end of a flexible cable, the other end of the flexible cable being for connecting to an external power supply; the output module comprising a same number of output interfaces as the input interfaces, each output interface being for electrical connection to all LEDs in an external area, each output interface being electrically connected to a corresponding input interface.

The present invention provides a connector, which comprises: an input module and an output module, wherein the input module and the output module being electrically connected; the input module comprising at least two input interfaces, the input interface being for connecting to an external power supply, the output module being for electrical connection to all LEDs in at least two external areas.

According to a preferred embodiment of the present invention, the input interface is a jack-type interface.

According to a preferred embodiment of the present invention, the jack-type interface is for plugging in one end of a flexible cable, and the other end of the flexible cable is for connecting to an external power supply.

According to a preferred embodiment of the present invention, the output module comprises a same number of output interfaces as the input interfaces, and each output Interface is for electrical connection to all LEDs in an external area.

According to a preferred embodiment of the present invention, the input module is located on a front side of the connector and the output module is located on a back side of the connector.

According to a preferred embodiment of the present invention, the connector has a shape rectangle or square.

The present invention provides an LED light bar, which comprises: a circuit board, LEDs and a connector; the LEDs and the connector being disposed on the circuit board, the circuit board being disposed with at least two areas for disposing LEDs, the connector comprising an input module and an output module, wherein the input module and the output module being electrically connected; the input module comprising at least two input interfaces, the input interface being for connecting to an external power supply, the output module being for electrical connection to all LEDs.

According to a preferred embodiment of the present invention, the input interface is a jack-type interface.

According to a preferred embodiment of the present invention, the jack-type interface is for plugging in one end of a flexible cable, and the other end of the flexible cable is for connecting to an external power supply.

According to a preferred embodiment of the present invention, the output module comprises a same number of output interfaces as the input interfaces, and each output interface is for electrical connection to all LEDs in an external area.

According to a preferred embodiment of the present invention, the input module is located on a front side of the connector and the output module is located on a back side of the connector.

According to a preferred embodiment of the present invention, the connector has a shape of rectangle or square.

According to a preferred embodiment of the present invention, the connector and the circuit board are formed in a single injection molding.

According to a preferred embodiment of the present invention, the connector is soldered to the circuit board.

The efficacy of the present invention is that to be distinguished from the state of the art. By disposing at least two input interfaces at the connector, the present invention realizes the use of a connector to control LEDs in a plurality of areas to increase the utilization of the connector and simplify the LED light bar structure. In the mean time, the improvement of the connector utilization results in the reduction in the number of connectors used so as to reduce the cost of LED light bar.

### BRIEF DESCRIPTION OF THE DRAWINGS

To make the technical solution of the embodiments according to the present invention, a brief description of the drawings that are necessary for the illustration of the embodiments will be given as follows. Apparently, the drawings described below show only example embodiments of the present invention and for those having ordinary skills in the art, other drawings may be easily obtained from these drawings without paying any creative effort. In the drawings:

FIG. 1 is a schematic view showing the structure of an embodiment of the connector according to the present invention;

FIG. 2 is a top view showing the structure of n embodiment of the connector according to the present invention;

FIG. 3 is a schematic view showing the circuit of an embodiment of the connector according to the present invention; and

FIG. 4 is a schematic view showing a part of an embodiment of an LED light bar according to the present invention.

### DETAILED DESCRIPTION OF THE PREFERRED EMBODIMENTS

The following refers to drawings and embodiment of the present invention for detailed description.

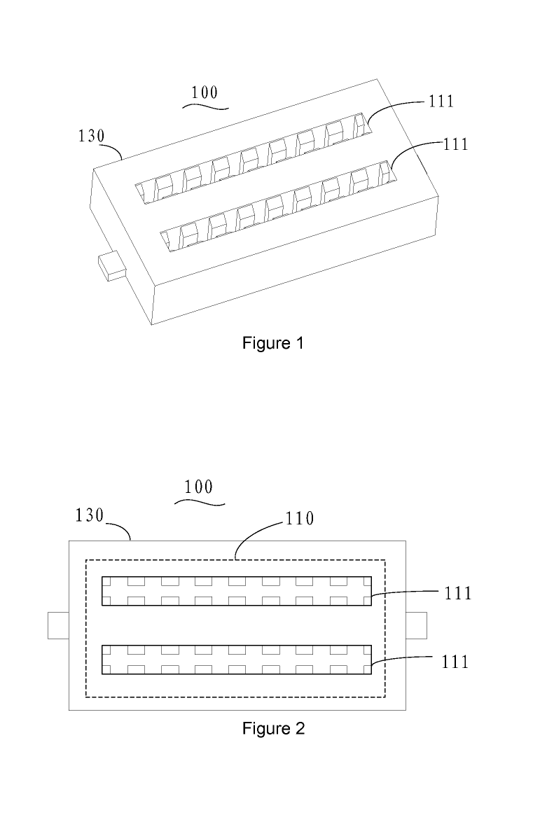

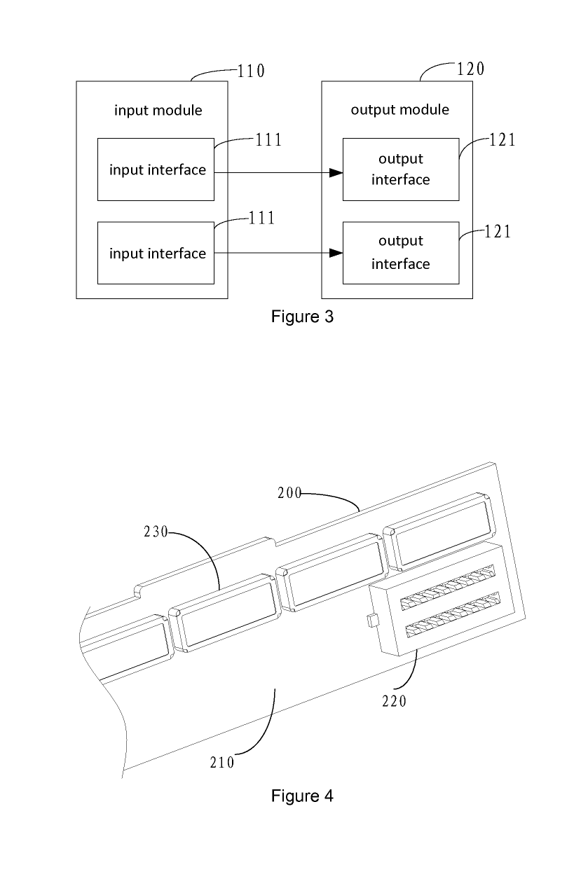

Referring to FIGS. 1-3, FIG. 1 is a schematic view showing the structure of an embodiment of the connector according to the present invention; FIG. 2 is a top view showing the structure of an embodiment of the connector according to the present invention; and FIG. 3 is a schematic view showing the circuit of an embodiment of the connector according to the present invention.

In the instant embodiment, a connector 100 comprises: a shell 130, an input module 110 and an output module 120, fixed inside the shell 130. The input module 110 and the output module 120 are electrically connected. The input module 100 comprises two input interfaces 111 and the input module 110 is for connecting to an external power supply, The output module 120 is for electrical connection to all LEDs in two corresponding external areas, wherein he two corresponding external areas are two areas on the LED light bar where the connector 100 is disposed on.

Specifically, the input interface 111 is a jack-type interface and is for plugging in one end of a flexible cable, and the other end of the flexible cable is for connecting to an external power supply. The input interface is electrically connected through the flexible cable to the external power supply, and through the output module 120 to realize supplying electricity to external LEDs, wherein the external LEDs are the LEDs disposed on the same circuit board as the connector 100. Correspondingly, each input interface 111 realizes power supply control to all LEDs in an area on the circuit board. The voltage of the external power supply is DC12V. It should be noted that the external power supply is not limited to 12V. The specific voltage is determined by the LED light bar where the connector 100 is disposed on.

Preferably, the output module 120 comprises a same number of output interfaces 121 as the input interfaces 111. Each output interface 121 and each input interface 111 are correspondingly connected and each output interface 121 is for electrical connection to all LEDs in an area of the same circuit board where the connector 100 is disposed on. Each input interface 111 realizes the power supply control to all LEDs of an area in the circuit board through corresponding output interface 121.

In the instant embodiment, the input module 110 is located on a front side of the connector 100 and the output module 120 is located on a back side of the connector 100. However, the present invention is not restricted to the disposition in the instant embodiment that the input module 110 is located on a front side of the connector 100 and the output module 120 is located on a back side of the connector 100. The connector 100 has a shape of a rectangle. Similarly, the present invention is not restricted to the disposition in the instant embodiment. The connector 100 can also be shaped as a square or other shape suitable for the structure of LED light bar where the connector 100 is disposed on.

For convenience of description, the embodiment shows that the input module 110 comprises two input interfaces 111 and realizes power supply control to all LEDs in two areas through the output module 120 correspondingly. However, the present invention is not restricted to the disposition in the instant embodiment of comprising two input interfaces 111 and realizing power supply control to all LEDs in two areas through the output module 120 correspondingly, The input module 110 can comprises more than two input interfaces 111, for example, the input module 110 can comprise three input interfaces 111. Also, the number of areas controlled by the connector is not necessarily the same as the number of input interfaces. For example, a connector 100 having two input interfaces 111 can also realize the power supply control to: all LEDs in one area. In addition; the input interface 111 is disposed as a jack-type interface for plugging in a flexible cable. However, the present invention is not restricted to the disposition in the instant embodiment of a jack-type interface for plugging in a flexible cable.

In the instant embodiment, the present invention realizes the use of a connector 100 to control more LEDs by disposing the connector 100 with two input interfaces 111 to improve utilization of connector 100 and meet the control demands of the complex LED light bar. In addition, each input interface 111 supplies power to an area on the circuit board so that the LEDs can be separately controlled by the area.

Referring to FIG. 4, FIG. 4 is a schematic view showing a part of an embodiment of an LED light bar according to the present invention. In the instant embodiment; an LED light bar 200 comprises: a circuit 210, a connector 220 and LEDs 230. The connector 220 and LEDs 230 are disposed on the circuit board 210. The connector 220 and the LEDs 230 are electrically connected, wherein the description of connector 220 is as in FIGS. 1-3, and will not be repeated here.

In the instant embodiment, the two input interfaces of the connector 220 are for connecting to an external power supply. The output module of the connector 220 is connected respectively with conductive wire of the circuit board 210 connecting all LEDs 230 in corresponding area. LEDs 230 are electrically connected to one of the conductive wires of the circuit board 210 connecting to the output module of the connector 220. The connector 220 is electrically connected to all LEDs 230 in corresponding areas through the circuit board 210 to realize power supply control to all LEDs 230 in corresponding areas, wherein the voltage external power supply is DC 12V. It should be noted that the external power supply is not limited to 12V. The specific voltage is determined by the LED light bar where the connector 200 is disposed on.

Preferably, each input interface of connector 220 is electrically connected through the output module to all LEDs 230 in an area of the circuit board 210 correspondingly. Through a plurality of input interfaces, the connector 220 realizes power supply control to all LEDs in a plurality of areas on the circuit board 210.

In a specific embodiment, the fixing manner of the circuit board 210 and the connector 220 comprises, but not limited to, (1) the connector 220 and the circuit board 210 are formed in a single injection molding, wherein the connector 220 and the circuit board 210 are formed in a single injection molding during manufacturing the circuit board 210; and (2) the connector 220 is soldered to the circuit board 210, wherein the connector 220 is soldered to the circuit board 210 during manufacturing LED light bar 200.

In the instant embodiment, by disposing at least two input interfaces 220 at the connector 220, the present invention realizes the use of a connector 220 to control LEDs 230 in a plurality of areas to increase the utilization of the connector 220 and simplify the structure of LED light bar 200. In the mean time, the improvement of the connector 220 utilization results in the reduction in the number of connectors used so as to reduce the cost of LED light bar 200.

Embodiments of the present invention have been described, but not intending to impose any unduly constraint to the appended claims. Any modification of equivalent structure or equivalent process made according to the disclosure and drawings of the present invention, or any application thereof, directly or indirectly, to other related fields of technique, is considered encompassed in the scope of protection defined by the clams of the present invention.

What is claimed is:

1. A connector, which comprises: an input module and an output module, wherein the input module and the output module being electrically connected;
the input module comprising at least two input interfaces, the input interface being a jack-type interface, the jack-type interface being for plugging in one end of a flexible cable, the other end of the flexible cable being for connecting to an external power supply;
the output module comprising a same number of output interfaces as the input interfaces, each output interface being for electrical connection to all LEDs in an external area, each output interface being electrically connected to a corresponding input interface.

2. A connector, which comprises: an input module and an output module, wherein the input module and the output module being electrically connected; the input module comprising at least two input interfaces, the input interface being for connecting to an external power supply, the output module being for electrical connection to all LEDs in at least two external areas.

3. The connector as claimed in claim 2, characterized in that the input interface is a jack-type interface.

4. The connector as claimed in claim 3, characterized in that the jack-type interface is for plugging in one end of a flexible cable, and the other end of the flexible cable is for connecting to an external power supply.

5. The connector as claimed in claim 2, characterized in that the output module comprises a same number of output interfaces as the input interfaces, and each output interface is for electrical connection to all LEDs in an external area.

6. The connector as claimed in claim 2, characterized in that the input module is located on a front side of the connector and the output module is located on a back side of the connector.

7. The connector as claimed in claim 2, characterized in that the connector has a shape rectangle or square.

8. An LED light bar, which comprises: a circuit board, LEDs and a connector; the LEDs and the connector being disposed on the circuit board, the circuit board being disposed with at least two areas for disposing LEDs, the connector comprising an input module and an output module, wherein the input module and the output module being electrically connected; the input module comprising at least two input interfaces, the input interface being for connecting to an external power supply, the output module being for electrical connection to all LEDs.

9. The light bar as claimed in claim 8, characterized in that the input interface is a jack-type interface.

10. light bar as claimed in claim 9, characterized in that the jack-type interface is for plugging in one end of a flexible cable, and the other end of the flexible cable is for connecting to an external power supply.

11. The light bar as claimed in claim 8, characterized in that the output module comprises a same number of output interfaces as the input interfaces, and each output interface is for electrical connection to all LEDs in an external area.

12. The light bar as claimed in claim 8, characterized in that the input module is located on a front side of the connector and the output module is located on a back side of the connector.

13. The light bar as claimed in claim 8, characterized in that the connector has a shape rectangle or square.

14. The light bar as claimed in claim 8, characterized in that the connector and the circuit board are formed in a single injection molding.

15. The light bar as claimed in claim 8, characterized in that the connector is soldered to the circuit board.
